(19) United States
(12) Patent Application Publication
(10) Pub. No.: US 2016/0086136 A1
(43) Pub. Date: Mar. 24, 2016

(54) SYSTEM AND METHOD FOR OBTAINING REAL-TIME UPDATES ON STATUS OF APPOINTMENTS OR TOKENS

(71) Applicants: Sujay Parth Pidara, Chicago, IL (US); Madhusudan Garg, Nagpur (IN); Vikas Garg, Nagpur (IN)

(72) Inventors: Sujay Parth Pidara, Chicago, IL (US); Madhusudan Garg, Nagpur (IN); Vikas Garg, Nagpur (IN)

(21) Appl. No.: 14/489,786

(22) Filed: Sep. 18, 2014

(51) Int. Cl. G06Q 10/10

(52) U.S. Cl. CPC G06Q 10/1095

(57) ABSTRACT

A method for dynamically scheduling an event between a first entity and a second entity based on an updated expected time is provided. The method includes (a) retrieving, a list of relevant second entities from a database of said second entities based on said at least one search criteria received from a device associated with said first entity, (b) allocating, an appointment with an initial expected time to said first entity from a available appointment times with at least one second entity from said list of relevant second entities on obtaining an appointment request from said first entity on an appointment screen specific to said second entity, (c) dynamically calculating, (i) a updated expected time of said appointment, or (ii) a current token, and (d) communicating said updated expected time of said appointment for display on said appointment screen at said device associated with said first entity.

### BACKGROUND

1. Technical Field

The embodiments herein generally relate to an event management system, and more particularly to system and method of dynamically scheduling an event between two entities without exchanging messages based on an updated expected time.

2. Description of the Related Art

In the current scenario, an appointment based meeting system is necessary to avoid unnecessary delay and aware of status of the appointment. For example, typically, in a medical environment, a patient takes an appointment or a token on the first come first served basis. If a practitioner made delay due to some medical emergency, the patient has to wait in a queue without aware of the status of his/her appointment and/or token schedule. One typical approach that addresses this problem is obtaining an appointment online, and through exchange of phone calls, short messaging services (SMS), or email, etc, the patient comes to know about a status of his/her appointment. The appointment and/or token time of a patient may be influenced by other appointment/tokens and time taken to complete each appointment and/or token. Accordingly, there needs for a system and method for managing an appointment and/or token and to obtain a real-time status of the appointment and/or the token without exchanging any communication.

### SUMMARY

In view of the foregoing, an embodiment herein provides a method for dynamically scheduling an event between a first entity and a second entity based on an updated expected time. The method includes (i) receiving, from a device associated with a first entity, at least one search criteria, (ii) retrieving, by a processor, a list of relevant second entities from a database of the second entities based on the at least one search criteria, (iii) communicating, available appointment times with their expected times for the list of relevant second entities for display at the device associated with the first entity, (iv) allocating, an appointment with an initial expected time to the first entity from the available appointment times with at least one second entity from the list of relevant second entities on obtaining an appointment request from the first entity on an appointment screen specific to the second entity, by the processor, (v) dynamically calculating, (a) a updated expected time of the appointment, or (b) a current token, on obtaining a subsequent request from the device associated with the first entity to view the appointment screen specific to the second entity, by the processor, and (vi) communicating, the updated expected time of the appointment for display on the appointment screen at the device associated with the first entity. The appointment screen includes a name of the second entity, and (a) a current appointment time between the first entity and the second entity, or (b) an available appointment time with the second entity. The current expected time is calculated based on at least one of (i) time associated with pending prior appointments or prior tokens, (ii) delay due to processing the prior appointments or tokens, (iii) delay introduced by the second entity for emergencies or unavailability, and (iv) the initial expected time. The delay is computed based on status of the prior appointments or the prior tokens that are indicated by the second entity.

The status of the prior appointments or the prior tokens may include at least one of (i) done, (ii) hold, and (iii) cancel. The initial expected time includes a duration at which the first entity meets with the second entity. The method may further includes, (i) processing from the first entity a description, (ii) determining an available entity name from a set of available entities names stored in a database, and (iii) associating the available entity name with the first description. The method may further includes displaying the updated expected time for the token or the appointment at a display unit of the device associated with the second entity. The updated expected time for the token or the appointment is obtained without a direct interaction with the second entity.

In another aspect, an event scheduling server to dynamically schedule an event between a first entity and a second entity based on an updated expected time is provided. The event scheduling server includes (i) a memory unit that stores (a) a set of modules, and (b) a database, and (ii) a processor that executes the set of modules. The database includes at least one of (a) an information associated with the event (b) information associated with a first entity, (c) information associated with a second entity, (d) information associated with an expected time for the token or the appointment. The set of modules includes (a) an input processing module, (b) an event scheduling information obtaining module, and (c) an updated expected time computing module. The input processing module executed by the processor, processes an input, from the first entity an indication to select at least one search criteria associated with the second entity. The event scheduling information obtaining module, executed by the processor, that obtains a list of relevant second entities from the database of the second entities based on the at least one search criteria. The event scheduling information obtaining module further includes (i) an appointment information obtaining module, executed by the processor, obtains available appointment times with their expected times for the list of relevant second entities for display at the device associated with the first entity, and (ii) an appointment allocating module, executed by the processor, allocates an appointment with an initial expected time to the first entity from the available appointment times with at least one second entity from the list of relevant second entities on obtaining an appointment request from the first entity on an appointment screen specific to the second entity, and (c) an updated expected time computing module, executed by the processor, that dynamically compute at least one of (i) a updated expected time of the appointment, or (ii) a current token, on obtaining a subsequent request from the device associated with the first entity to view the appointment screen specific to the second entity.

The status of the prior appointments or the prior tokens may include at least one of (i) done, (ii) hold, and (iii) cancel. The initial expected time may include a duration at which the first entity meets with the second entity. The event scheduling server may include an updated expected time status indication module, executed by the processor, which communicates the updated expected time of the appointment for display on the appointment screen at the device associated with the first entity. The appointment screen may include a name of the second entity, and (i) a current appointment time between the first entity and the second entity, or (ii) an available appointment time with the second entity. The current expected time is calculated based on at least one of (i) time associated with pending prior appointments or prior tokens, (ii) delay due to processing the prior appointments or tokens, (iii) delay introduced by the second entity for emergencies or unavailability, and (iv) the initial expected time. The delay is computed based on status of the prior appointments or the prior tokens that are indicated by the second entity.

In yet another aspect, a user device to receive a schedule of an event between a first entity and a second entity based on an updated expected time is provided. The user device includes (i) a display unit, and (ii) a processor. The user device is configured to receive a schedule of an event between a first entity and a second entity based on an updated expected time from an event scheduling server. The event scheduling server, (a) receive at least one search criteria from a device associated with the first entity, (b) retrieve a list of relevant second entities from a database of the second entities based on the at least one search criteria, (c) communicate available appointment times with their expected times for the list of relevant second entities for display at the device associated with the first entity, (d) allocate, by the processor, an appointment with an initial expected time to the first entity from the available appointment times with at least one second entity from the list of relevant second entities on obtaining an appointment request from the first entity on an appointment screen specific to the second entity, (e) dynamically calculate, by the processor, (i) a updated expected time of the appointment, or (ii) a current token, on obtaining a subsequent request from the device associated with the first entity to view the appointment screen specific to the second entity, and (f) communicate the updated expected time of the appointment for display on the appointment screen at the device associated with the first entity.

The appointment screen may include a name of the second entity, and (i) a current appointment time between the first entity and the second entity or (ii) an available appointment time with the second entity. The current expected time may calculated based on at least one of (i) time associated with pending prior appointments or prior tokens, (ii) delay due to processing the prior appointments or tokens, (iii) delay introduced by the second entity for emergencies or unavailability, and (iv) the initial expected time. The delay may computed based on status of the prior appointments or the prior tokens that are indicated by the second entity. The status of the prior appointments or the prior tokens may include at least one of (i) done, (ii) hold, and (iii) cancel. The initial expected time may include a duration at which the first entity meets with the second entity. The user device may further configured to (i) process from the first entity a description, (ii) determine an available entity name from a set of available entities names stored in a database, and (iii) associate the available entity name with the first description.

The user device may further configured to display the updated expected time for the token or the appointment at a display unit of the device associated with the second entity. The updated expected time for the token or the appointment may obtain without a direct interaction with the second entity. The updated expected time for the token or the appointment may include at least one of (i) expected time is delayed by an hour, (ii) expected time is preponed by ten minutes to a scheduled time.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view illustrating an event scheduling application implemented in one or more computing device interacts with an event scheduling server for obtaining a real-time status of an appointment/token between one or more entities according to an embodiment herein;

FIG. 2 illustrates an exploded view of the event scheduling application implemented in the computing device of FIG. 1 according to an embodiment herein;

FIG. 3 illustrates an exploded view of the event scheduling server of FIG. 1 according to an embodiment herein;

FIG. 4 illustrates a user interface view of displaying an expected time for upcoming appointments/tokens using the event scheduling application implemented in the computing device associated with the first entity according to an embodiment herein;

FIG. 5 illustrates a user interface view of a status updation field of the event scheduling application implemented in the computing device associated with the second entity of FIG. 1 according to an embodiment herein;

FIG. 6 illustrates a user interface view of a delay time addition field of the event scheduling application implemented in the computing device associated with the second entity of FIG. 1 according to an embodiment herein;

FIG. 7 is a table view illustrates a process of calculating the expected time associated with token/appointment according to an embodiment herein;

FIG. 8 illustrates an exploded view of the one or more computing devices of FIG. 1 according to an embodiment herein; and

FIG. 9 illustrates a schematic diagram of a computer architecture used in accordance with the embodiments herein; and

FIG. 10 is a flow diagram illustrating a method for dynamically scheduling an event between a first entity and a second entity based on an updated expected time according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

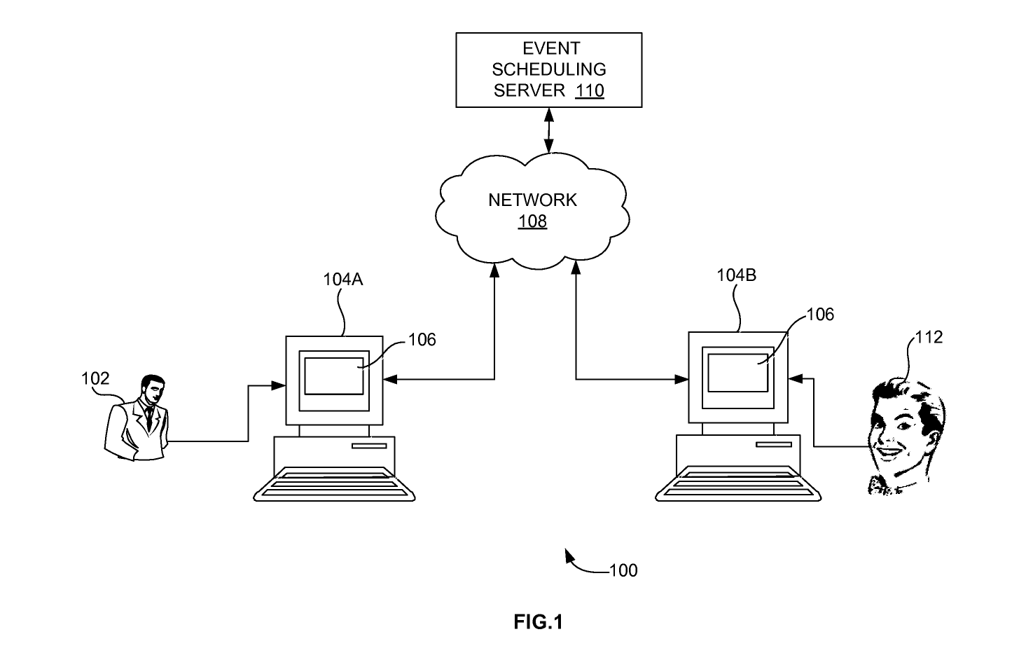

As mentioned, there needs for a system and method for managing an appointment and/or token and to obtain a real-time status of the appointment and/or the token without exchanging any communication. The event scheduling application which is implemented in one or more computing device that interacts with an event scheduling server for obtaining a real-time status of an appointment/token between one or more entities without exchanging any communication (e.g., a SMS, a phone call, an email, etc). The updated expected time is displayed in the display unit of a computing device associated with a user. Referring now to the drawings, and more particularly to FIG. 1 through 10, where similar reference characters denote corresponding features consistently throughout the figures, preferred embodiments are described herein.

FIG. 1 is a system view illustrating an event scheduling application 106 implemented in one or more computing device 104A-B interacts with an event scheduling server 110 for obtaining a real-time status of an appointment/token between one or more entities according to an embodiment herein. The system view 100 includes a first entity 102, a computing device associated with the first entity 104A, an event scheduling application 106, a network 108, the event scheduling server 110, a second entity 112, and a computing device associated with the second entity 104B. The event scheduling application 106 schedules an event may be, but not limited to, a meeting, a consultation, an appointment, an availing of a service, etc. The event scheduling server 110 includes the information about the list of doctors and availability of doctors which are updated on the one or more computing device 104A-B. The first entity 102 may be a user (e.g., a patient), a service seeker (e.g., a person standing in a queue for obtaining a token for a doctor), a client, etc.

The second entity 112 may be a doctor, a user, a service provider, a dentist, a physician, a practitioner, a client, a medical advisor, a medical service provider, an assistant of the medical service provider, a restaurant. In one embodiment, the network 108 may be an internet, or a broadcast network. The one or more computing device 104A-B may be a mobile phone, a cellular phone, a tablet PC, a notebook, a personal computer (PC), and/or a laptop. The one or more computing device 104A-B may be a computing device associated with a user. The first entity 102 interacts with the event scheduling server 110 through event scheduling application 106 implemented in the computing device 104A to obtain a token or an appointment with the second entity 112. The event scheduling application 106 further enables the first entity 102 to obtain a real-time update on a status of his/her token or an appointment (e.g., an updated expected time associated with the token or the appointment) with the second entity 112 without exchanging any communication (e.g., a SMS, a phone call, an email, etc).

In one embodiment, the event scheduling application 106 interacts with the event scheduling server 110 through the network 108. For example, the first entity 102 is a patient and the second entity 112 may be a doctor. The event scheduling application 106 at the computing device 104A enables the patient to search for a list of doctors, and selects a doctor for scheduling an appointment or obtaining a token. An expected time (e.g., 11 AM) that indicates a duration at which the patient may meet the doctor is obtained and displayed at a display unit of the one or more computing device 104A-B.

Then the doctor updates a status (e.g., done, hold, and/or cancelled) of the appointments or the tokens associated with the patient. For example, a delay (e.g., 15 minutes) from the expected time corresponding to the token or the appointment of the patient is determined using the event scheduling application 106 at the event scheduling server 110. Then, an updated expected time (e.g., 11.15 AM) is dynamically determined in real time. The updated expected time is obtained and displayed at the display unit when the patient accesses the event scheduling application 106 at his/her user device. Accordingly, the patient obtains a real-time update on a status of his/her token or appointment without exchanging any communication. In exemplary embodiment, a patient can reserve time for a dialysis unit at a hospital/clinic using their computing device.

In another embodiment, the event scheduling application 106 enables the first entity 102 to obtain a real-time update on a status of his/her token or appointment with the second entity 112 when the first entity 102 stands in a queue. For example, the first entity 102 may be a person standing in a queue for paying an electricity bill. The event scheduling application 106 at the person's device, obtains an expected time (e.g., 3 PM) that indicates when he/she reaches to the front of the queue. As described above, the second entity 112 (i.e., a queue owner) updates status of tokens associated with other persons using the event scheduling application 106 respectively. A delay (e.g., 30 minutes) from the expected time corresponding to the token of the person is determined based on status of tokens associated with other persons in the queue. An updated expected time (e.g., 3.30 PM) is determined. The updated expected time is obtained and displayed at the display unit when the person accesses the event scheduling application 106 at his/her computing device.

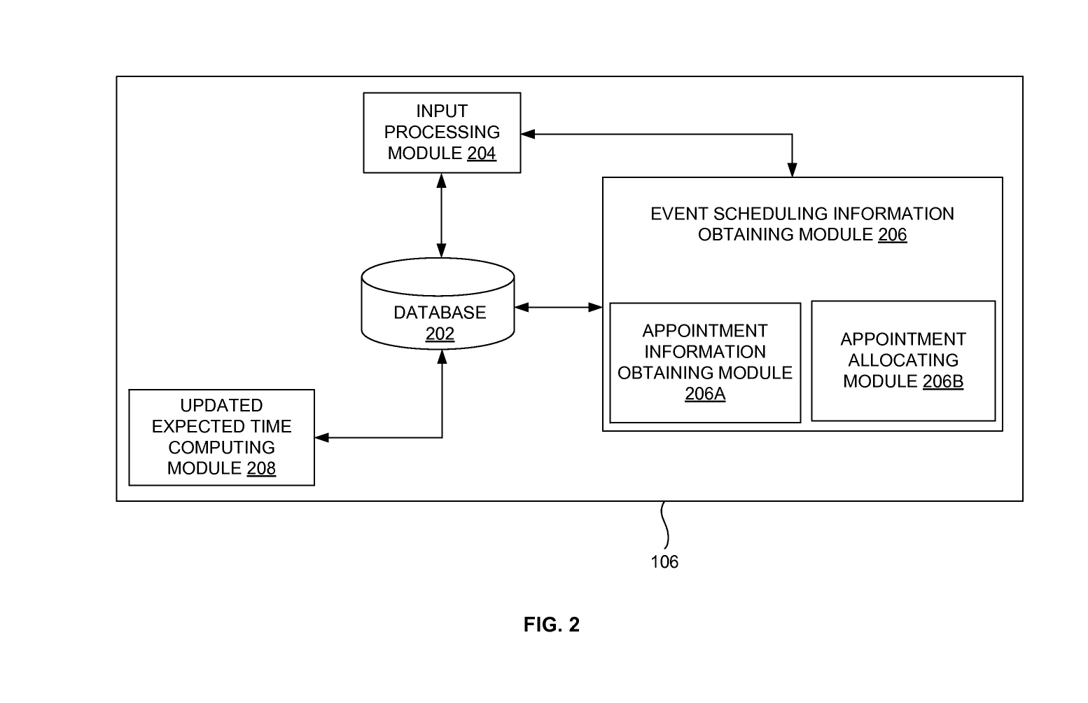

FIG. 2 illustrates an exploded view of the event scheduling application 106 implemented in the computing device 104A of FIG. 1 according to an embodiment herein. The event scheduling application 106 includes a database 202, an input processing module 204, event scheduling information obtaining module 206, and an updated expected time computing module 208. The database 202 stores (a) an information associated with the event (b) information associated with the first entity (e.g., a patient), (c) information associated with a second entity (e.g., the list of the doctors, addresses of the doctors, consulting timings of the doctors, availability of the doctors), (d) information associated an updated expected time for a token or an appointment, and (e) information associated with an expected time for the token or the appointment. The input processing module 204 which processes the input given by the first entity 102. In one embodiment, the input may be a search for doctor, determine the availability of doctors, etc. In another embodiment, the input may be a request for appointment, request for token, etc.

The event scheduling information obtaining module 206 obtains schedule information associated with the event between the first entity and the second entity based on the indication. The event scheduling information obtaining module 206 further includes (i) an appointment information obtaining module 206A and (ii) an appointment allocating module 206B. The appointment information obtaining module 206A that obtains a list of relevant second entities from the database of the second entities based on the one or more search criteria. In one embodiment, available appointment times with their expected times is communicated for the list of relevant second entities for display at the device associated with the first entity. The appointment allocating module 206B that allocates an appointment with an initial expected time to the first entity from the available appointment times with at least one second entity from the list of relevant second entities on obtaining an appointment request from the first entity on an appointment screen specific to the second entity. The appointment screen may include a name of the second entity, and (i) a current appointment time between the first entity and the second entity or (ii) an available appointment time with the second entity.

An expected time obtaining module (not shown in figure) obtains the expected time in real time. For example, the first entity 102 may expect a time (e.g. 11 AM) for his/her appointment with the second entity 112. The updated expected time computing module 208 that dynamically obtains an updated expected time for a current token, or the appointment on obtaining a subsequent request from the device associated with the first entity to view the appointment screen specific to the second entity. In one embodiment, the updated expected time is computed based on at least one of (i) time associated with pending prior appointments or a prior tokens, (ii) delay due to processing the prior appointments or tokens, (iii) delay introduced by the second entity for emergencies or unavailability, and (iv) the initial expected time. The delay is computed based on status of the prior appointments or the prior tokens that are indicated by the second entity. For example, if any delay occurs in the expected time (e.g. 11AM) of the first entity 102, the event scheduling server 110 may compute the delay time (e.g., 10 minutes) and update into the computing device 104A.

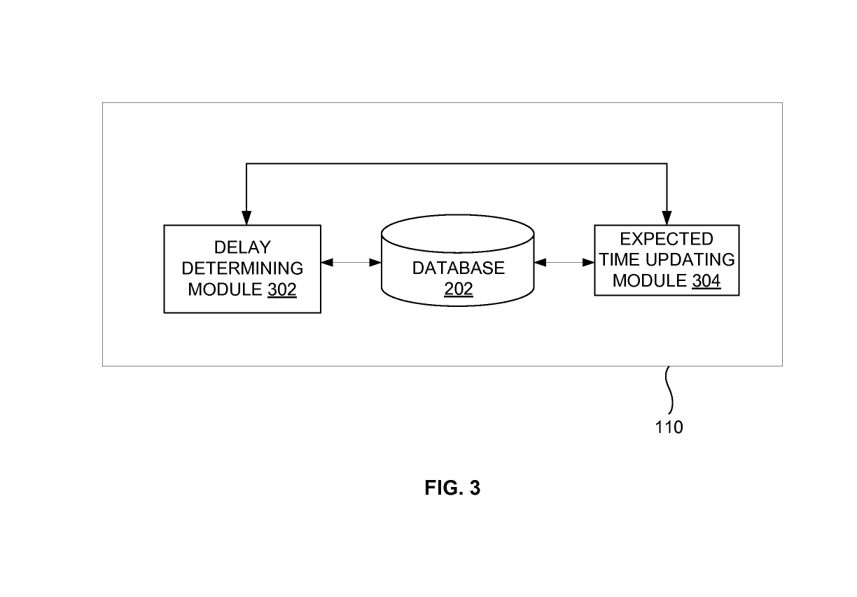

FIG. 3 illustrates an exploded view 300 of the event scheduling server 110 of FIG. 1 according to an embodiment herein. The event scheduling server 110 which includes a database 202, a delay determining module 302 and an expected time updating module 304. The database 202 stores delayed time, and scheduled time. The delay determining module 302 which determines a delay time of upcoming appointment. In one embodiment, the delay is computed based on status of the prior appointments or the prior tokens that are indicated by the second entity 112. The expected time updating module 304 which updates the expected time of the token or appointments on the computing device 104A.

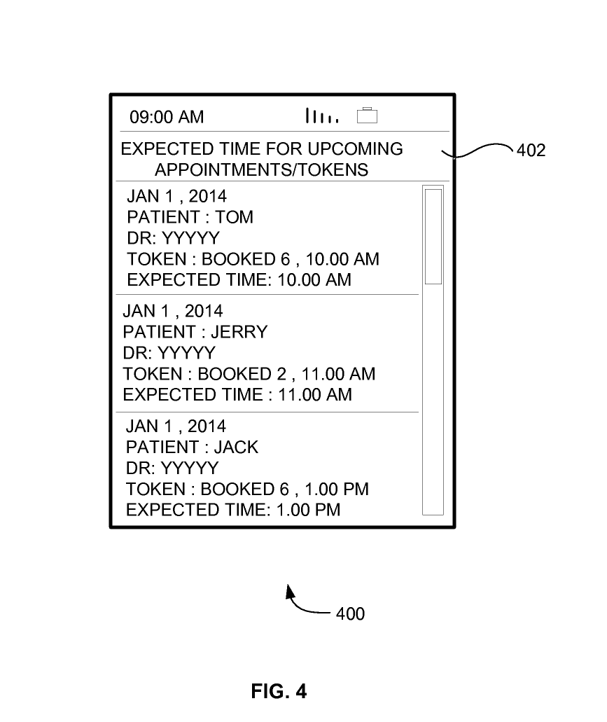

FIG. 4 illustrates a user interface view 400 of displaying an expected time for upcoming appointments/tokens using the event scheduling application 106 implemented in the computing device 104A associated with the first entity 102 according to an embodiment herein. The user interface view 400 includes the expected time for upcoming appointments/tokens field 402. The expected time for upcoming appointments/tokens field 402 includes expected time information associated with upcoming token/appointments. For example, a patient name, a doctor name, a token number/time associated with an event, and en expected time associated with the event. The updated expected time associated with the event may get displayed in the computing device 104A associated with the first entity 102.

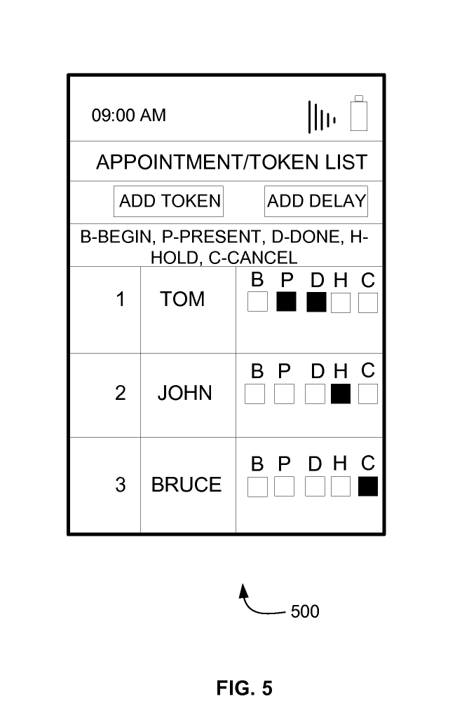

FIG. 5 illustrates a user interface view 500 of a status updation field of the event scheduling application 106 implemented in the computing device 104B associated with the second entity 112 of FIG. 1 according to an embodiment herein. The user interface view 500 includes the status updation field associated with list of appointments/tokens. The status associated with list of appointments/tokens is represented as B-Begin, P-Present, D-Done, H-Hold, C-Cancel. The second entity 112 updates the status of the token/appointments in the computing device 104B. For example, a first patient “Tom” and the corresponding status are P-present and D-Done. Similarly, a second patient “John” and the corresponding status is H-Hold. Similarly, third patient “Bruce” and the corresponding status is C-Cancel. The status updation associated with the event may get displayed in the computing device 104B associated with the second entity 112.

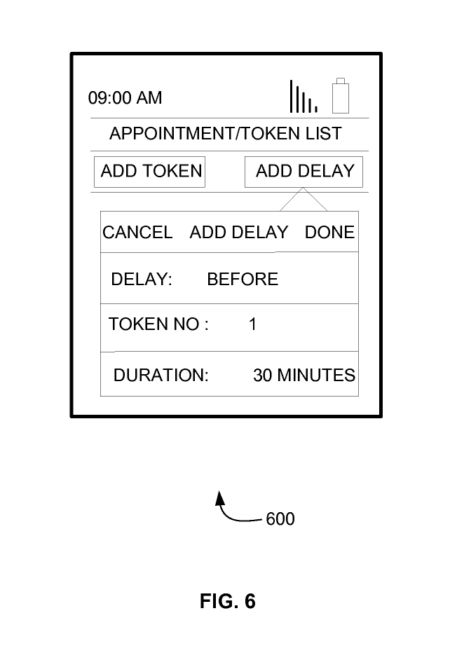

FIG. 6 illustrates a user interface view 600 of a delay time addition field of the event scheduling application 106 implemented in the computing device 104B associated with the second entity 112 of FIG. 1 according to an embodiment herein. The user interface view 600 includes delay time information associated with list of token/appointments. The second entity 112 may edit the field to update delay status information associated with tokens/appointments. For example, the second entity 112 updates the delay time by clicking “Add delay” field. The token number is “1” and corresponding delay duration is “30 minutes”. The delay time status associated with the event may get displayed in the computing device 104B associated with the second entity 112.

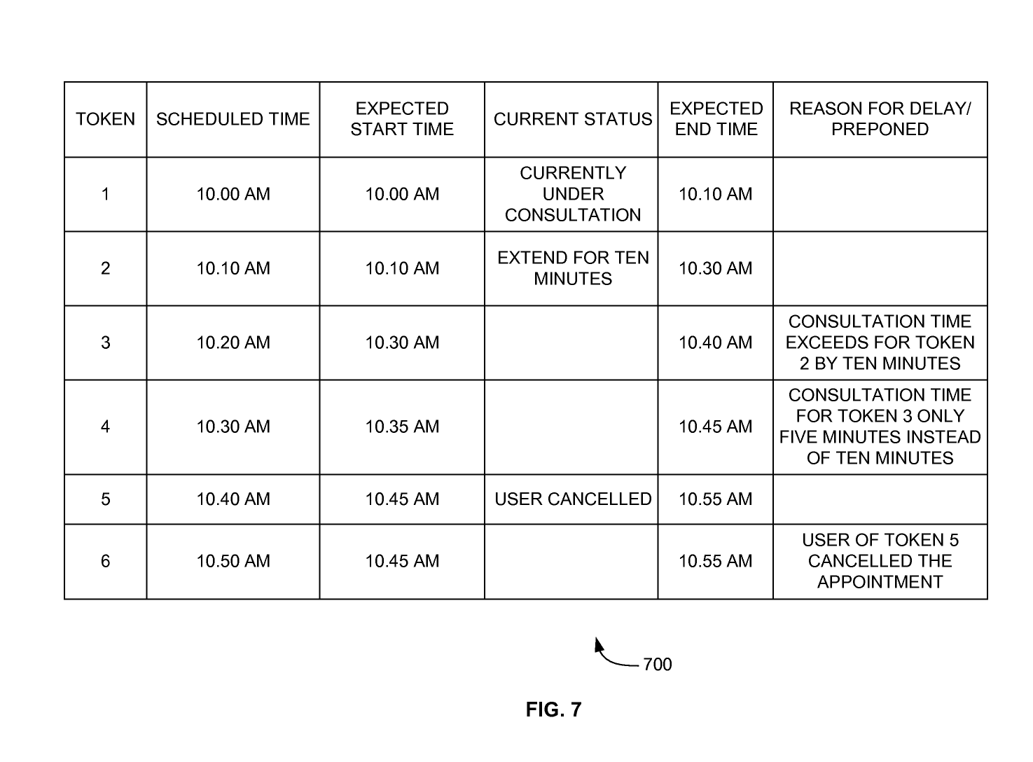

FIG. 7 is a table view illustrates a process of calculating the expected time associated with token/appointment according to an embodiment herein. The table view further includes a token field, a scheduled time field, an expected start time field, a current status field, an expected end time field, and a reason for delay/preponed field. The token field further includes a list of tokens represented as token 1, token 2, token 3, token 4, token 5, and token 6 as shown in the table view FIG. 7. The scheduled time field further includes a list of scheduled timings of corresponding tokens. The expected start time field further includes a list of expected start timings of the corresponding tokens. The current status field includes current status of the timings of the corresponding tokens.

The reason for delay/preponed field includes reasons for delay or preponed of the appointment time. For example, the scheduled time is 10.00 AM for token 1, the expected start time for the token 1 is 10.00 AM and expected end time for the token 1 is 10.10 AM. Accordingly the current status for token 1 is “currently under consultation”. For the token 2, the actual scheduled time is 10.10 AM and the expected start time is 10.10 AM. If there is a delay for 10 minutes in token 2, the expected end time may be 10.30 AM.

According to delay in previous token, there may be a change in expected start time of upcoming tokens. For token 3, the scheduled time is 10.20 AM. Because of delay in token 2 the expected start time of token 2 may be 10.30 AM and the expected end time is 10.40 AM. For token 4, the scheduled time may be 10.30 AM. Then, the expected start time of token 4 is 10.35 AM because of consultation time taken by token 3 is five minutes instead of ten minutes. Accordingly the expected end time may be 10.45 AM. If the token 5 is cancelled by the user with the token 5, the expected start time of token 6 may be 10.45 AM and the expected end time of token 6 may be 10.55 AM.

Similarly, whenever a token/appointment state changes then total remaining time is updated. Similarly, whenever a token or appointment is taken, the token/appointment duration is saved. Similarly, whenever a delay is added, it is inserted at appropriate position in the token/apt list so that quick calculation of remaining time can be done without linearly searching all the tokens/appointment. Expected time calculation for a token/appointment:

Expected Time=(Office start time or current time whichever is greater)+Total Remaining time−Current Token Elapsed Time.

Then,

Elapsed time=Current time−Start time, If elapsed time>token duration then use token duration.

To show expected time to a user for a booked token/appointment

Expected Time=(Sum of durations for a specific doctor, establishment and slot where token number is less than patient token)−Current Token Elapsed Time.

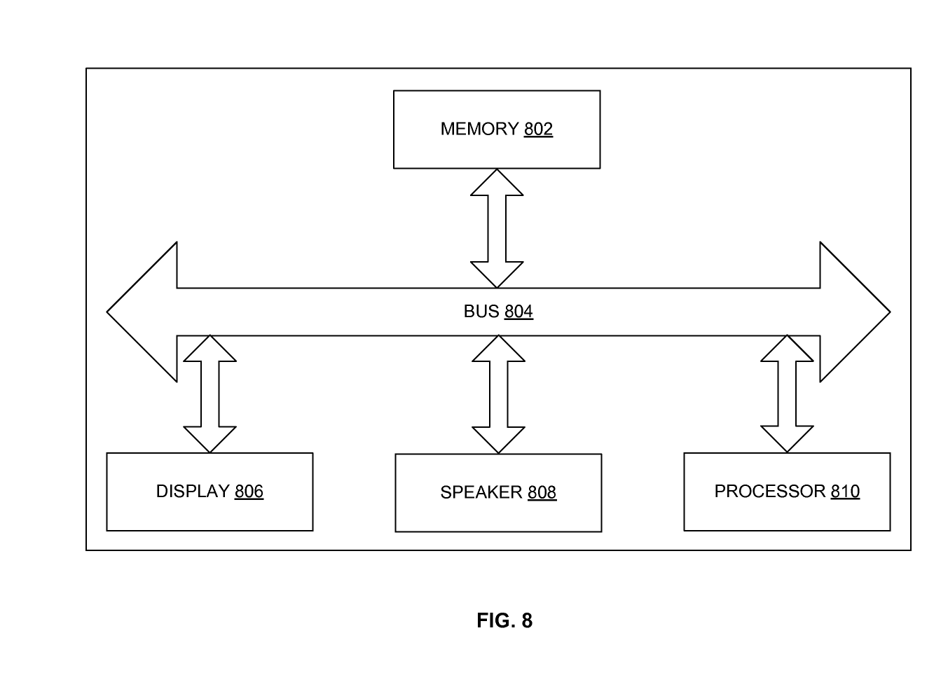

FIG. 8 illustrates an exploded view of the one or more computing device 104A-B of having an a memory 802 having a set of computer instructions, a bus 804, a display 806, a speaker 808, and a processor 810 capable of processing a set of instructions to perform any one or more of the methodologies herein, according to an embodiment herein.

The processor 810 may also enable digital content to be consumed in the form of video for output via one or more displays 806 or audio for output via speaker and/or earphones 808. The processor 810 may also carry out the methods described herein and in accordance with the embodiments herein.

Digital content may also be stored in the memory 802 for future processing or consumption. The memory 802 may also store program specific information and/or service information (PSI/SI), including information about digital content (e.g., the detected information bits) available in the future or stored from the past. A user of the one or more computing device 104A-B may view this stored information on display 806 and select an item of for viewing, listening, or other uses via input, which may take the form of keypad, scroll, or other input device(s) or combinations thereof. When digital content is selected, the processor 810 may pass information. The content and PSI/SI may be passed among functions within the one or more computing device 104A-B using the bus 804.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

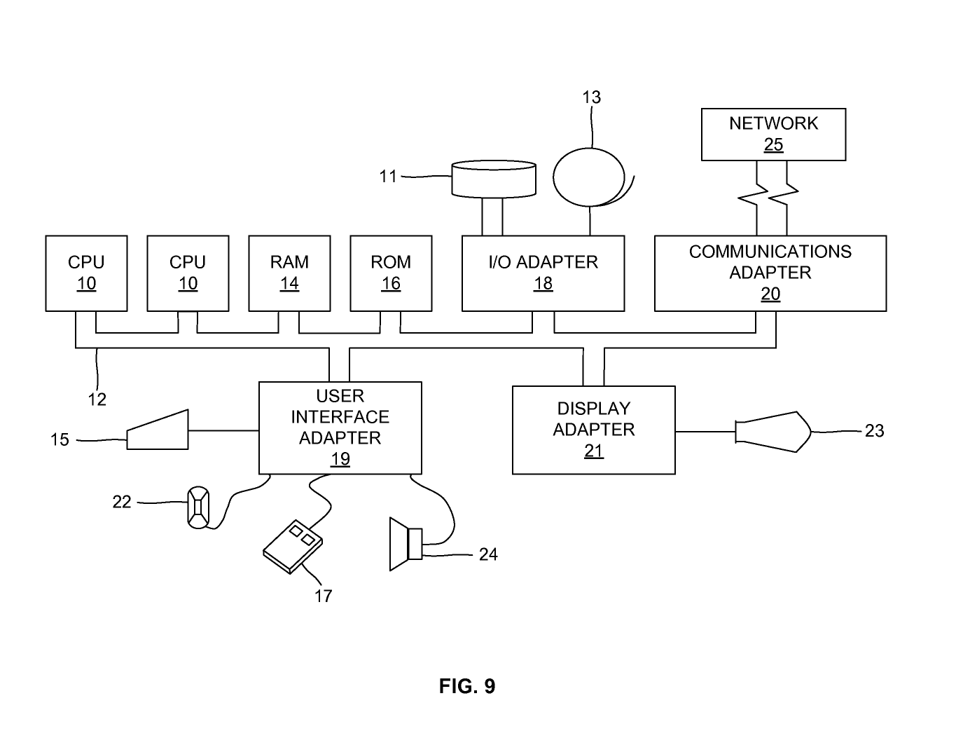

A representative hardware environment for practicing the embodiments herein is depicted in FIG. 9. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

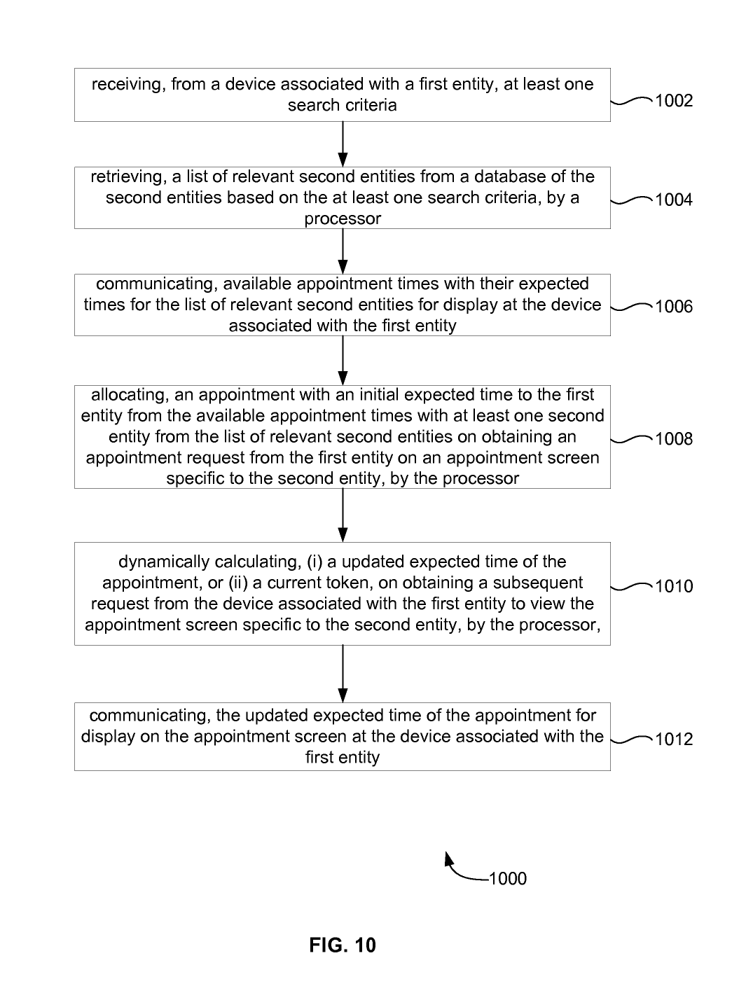

FIG. 10 is a flow diagram illustrating a method for dynamically scheduling an event between a first entity and a second entity based on an updated expected time according to an embodiment herein. In step 1002, at least one search criteria received from a device associated with the first entity. In step 1004, a list of relevant second entities is retrieved by a processor from a database of the second entities based on the at least one search criteria. In step 1006, available appointment times with their expected times for the list of relevant second entities is communicated for display at the device associated with the first entity. In step 1008, an appointment with an initial expected time to the first entity is allocated by the processor from the available appointment times with at least one second entity from the list of relevant second entities on obtaining an appointment request from the first entity on an appointment screen specific to the second entity. The appointment screen includes a name of the second entity, and (i) a current appointment time between the first entity and the second entity or (ii) an available appointment time with the second entity. In step 1010, (i) a updated expected time of the appointment, or (ii) a current token, is dynamically calculated by the processor, on obtaining a subsequent request from the device associated with the first entity to view the appointment screen specific to the second entity. The current expected time is calculated based on at least one of (i) time associated with pending prior appointments or prior tokens, (ii) delay due to processing the prior appointments or tokens, (iii) delay introduced by the second entity for emergencies or unavailability, and (iv) the initial expected time. The delay is computed based on status of the prior appointments or the prior tokens that are indicated by the second entity. In step 1012, the updated expected time of the appointment is communicated for display on the appointment screen at the device associated with the first entity. The status of the prior appointments or the prior tokens may include at least one of (i) done, (ii) hold, and (iii) cancel.

The initial expected time may include a duration at which the first entity meets with the second entity. The method may further include, (i) a description is processed from the first entity, (ii) an available entity name is determined from a set of available entities names stored in a database, and (iii) the available entity name is associated with the first description. The method may further include the updated expected time for the token or the appointment is displayed at a display unit of the device associated with the second entity. The updated expected time for the token or the appointment is obtained without a direct interaction with the second entity.

The event scheduling application 106 supports in storing appropriate data and then calculate exact time when a token or appointment turn comes. Providing an easy way for two entities to know each other using any device that when corresponding token/appointment turn is coming without being intrusive on each other and without requiring them to do a direct communication through email, phone or messages. The users save lot of time as they need not wait unnecessarily and appointment/token giving party can avoid crowded waiting rooms/receptions. In the medical field, it becomes very advantageous as sick patients or vulnerable people like kids and seniors do not have wait at the reception where they can get sicker while waiting or catch new diseases from other people. As doctor marks appointment/token complete and the user checks their booked appointment/token then expected time is shown in real time.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for dynamically scheduling an event between a first entity and a second entity based on an updated expected time, said method comprising:
(a) receiving at least one search criteria from a device associated with said first entity;
(b) retrieving, by a processor, a list of relevant second entities from a database of said second entities based on said at least one search criteria;
(c) communicating available appointment times with their expected times for said list of relevant second entities for display at said device associated with said first entity;
(d) allocating, by said processor, an appointment with an initial expected time to said first entity from said available appointment times with at least one second entity from said list of relevant second entities on obtaining an appointment request from said first entity on an appointment screen specific to said second entity, wherein said appointment screen comprises a name of said second entity, and (i) a current appointment time between said first entity and said second entity or (ii) an available appointment time with said second entity;
(e) dynamically calculating, by said processor, (i) a updated expected time of said appointment, or (ii) a current token, on obtaining a subsequent request from said device associated with said first entity to view said appointment screen specific to said second entity, wherein said updated expected time is calculated based on at least one of (i) time associated with pending prior appointments or prior tokens, (ii) delay due to processing said prior appointments or tokens, (iii) delay introduced by said second entity for emergencies or unavailability, and (iv) said initial expected time, wherein said delay is computed based on status of said prior appointments or said prior tokens that are indicated by said second entity; and
(f) communicating said updated expected time of said appointment for display on said appointment screen at said device associated with said first entity.

2. The method of claim 1, wherein said status of said prior appointments or said prior tokens comprises at least one of (i) done, (ii) hold, and (iii) cancel.

3. The method of claim 1, wherein said initial expected time comprises a duration at which the first entity meet with said second entity.

4. The method of claim 1, further comprising, (i) processing from said first entity a description, (ii) determining an available entity name from a set of available entities names stored in a database, and (iii) associating said available entity name with said first description.

5. The method of claim 1, further comprising displaying said updated expected time for said token or said appointment at a display unit of said device associated with said second entity, wherein said updated expected time for said token or said appointment is obtained without a direct interaction with said second entity.

6. An event scheduling server to dynamically schedule an event between a first entity and a second entity based on an updated expected time, said event scheduling server comprising:
(i) a memory unit that stores (a) a set of modules, and (b) a database, wherein said database comprises at least one of (a) an information associated with said event (b) information associated with a first entity, (c) information associated with a second entity, (d) information associated with an expected time for said token or said appointment;
(ii) a processor that executes said set of modules, wherein said set of modules comprise:
(a) a input processing module, executed by said processor, that processes an input, from said first entity an indication to select at least one search criteria associated with said second entity;
(b) an event scheduling information obtaining module, executed by said processor, that obtains a list of relevant second entities from said database of said second entities based on said at least one search criteria, said event scheduling information obtaining module further comprising:
(i) an appointment information obtaining module, executed by said processor, that obtains available appointment times with their expected times for said list of relevant second entities for display at said device associated with said first entity; and
(ii) an appointment allocating module, executed by said processor, that allocates an appointment with an initial expected time to said first entity from said available appointment times with at least one second entity from said list of relevant second entities on obtaining an appointment request from said first entity on an appointment screen specific to said second entity; and
(c) an updated expected time computing module, executed by said processor, that dynamically compute at least one of (i) a updated expected time of said appointment, or (ii) a current token, on obtaining a subsequent request from said device associated with said first entity to view said appointment screen specific to said second entity.

7. The event scheduling server of claim 6, wherein said status of said prior appointments or said prior tokens comprises at least one of (i) done, (ii) hold, and (iii) cancel.

8. The event scheduling server of claim 6, wherein said initial expected time comprises a duration at which the first entity meet with said second entity.

9. The event scheduling server of claim 6, further comprises, an updated expected time status indication module, executed by said processor, which communicates said updated expected time of said appointment for display on said appointment screen at said device associated with said first entity.

10. The event scheduling server of claim 6, wherein said appointment screen comprises a name of said second entity, and (i) a current appointment time between said first entity and said second entity or (ii) an available appointment time with said second entity.

11. The event scheduling server of claim 6, wherein said current expected time is calculated based on at least one of (i) time associated with pending prior appointments or prior tokens, (ii) delay due to processing said prior appointments or tokens, (iii) delay introduced by said second entity for emergencies or unavailability, and (iv) said initial expected time, wherein said delay is computed based on status of said prior appointments or said prior tokens that are indicated by said second entity.

12. A user device to receive a schedule of an event between a first entity and a second entity based on an updated expected time, said user device comprising:
(i) a display unit; and
(ii) a processor, wherein said user device is configured to receive a schedule of an event between a first entity and a second entity based on an updated expected time from an event scheduling server, and wherein said event scheduling server:
(a) receive at least one search criteria from a device associated with said first entity;
(b) retrieve a list of relevant second entities from a database of said second entities based on said at least one search criteria;
(c) communicate available appointment times with their expected times for said list of relevant second entities for display at said device associated with said first entity;
(d) allocate, by said processor, an appointment with an initial expected time to said first entity from said available appointment times with at least one second entity from said list of relevant second entities on obtaining an appointment request from said first entity on an appointment screen specific to said second entity, wherein said appointment screen comprises a name of said second entity, and (i) a current appointment time between said first entity and said second entity or (ii) an available appointment time with said second entity;
(e) dynamically calculate, by said processor, (i) a updated expected time of said appointment, or (ii) a current token, on obtaining a subsequent request from said device associated with said first entity to view said appointment screen specific to said second entity; and
(f) communicate said updated expected time of said appointment for display on said appointment screen at said device associated with said first entity.

13. The user device of claim 12, wherein said updated expected time is calculated based on at least one of (i) time associated with pending prior appointments or prior tokens, (ii) delay due to processing said prior appointments or tokens, (iii) delay introduced by said second entity for emergencies or unavailability, and (iv) said initial expected time, wherein said delay is computed based on status of said prior appointments or said prior tokens that are indicated by said second entity.

14. The user device of claim 12, wherein said status of said prior appointments or said prior tokens comprises at least one of (i) done, (ii) hold, and (iii) cancel.

15. The user device of claim 12, wherein said initial expected time comprises a duration at which the first entity meet with said second entity.

16. The user device of claim 12, wherein said user device is further configured to (i) process from said first entity a description, (ii) determine an available entity name from a set of available entities names stored in a database, and (iii) associate said available entity name with said first description.

17. The user device of claim 12, wherein said user device is further configured to display said updated expected time for said token or said appointment at a display unit of said device associated with said second entity, wherein said updated expected time for said token or said appointment is obtained without a direct interaction with said second entity.

18. The user device of claim 12, wherein updated expected time for said token or said appointment comprises at least one of (i) expected time is delayed by an hour, (ii) expected time is preponed by ten min to a scheduled time.
